(19) United States
(12) Patent Application Publication
(10) Pub. No.: US 2024/0173948 A1
(43) Pub. Date: May 30, 2024

(54) LAMINATE COMPRISING A POLYETHYLENE POLYMER LAYER AND AN ELASTOMER LAYER CONTAINING TWO ELASTOMERS

(71) Applicant: Gummiwerk KRAIBURG GmbH & Co. KG, Waldkraiburg (DE)

(72) Inventor: Runsheng Lue, Waldkraiburg (DE)

(21) Appl. No.: 18/519,627

(22) Filed: Nov. 27, 2023

(30) Foreign Application Priority Data
Nov. 25, 2022 (DE) 10 2022 131 267.4

(51) Int. Cl. B32B 27/08; B32B 7/12; B32B 27/32

(52) U.S. Cl. CPC B32B 27/08; B32B 7/12; B32B 27/32; B32B 2262/0253; B32B 2262/101; B32B 2262/106; B32B 2305/08; B32B 2603/00

(57) ABSTRACT

The present invention relates to a laminate having at least two layers, wherein the first layer i) has at least one polyethylene polymer and the second layer ii) has at least one first elastomer (E1) and at least one second thermoplastic elastomer (E2). The present invention further relates to a layer composite molding having the laminate bonded to a fiber-reinforced plastic, to a process for producing the layer composite molding, to a wind turbine having the layer composite moulding, and to the use of the laminate according to the invention in wind energy installations.

### BACKGROUND OF THE INVENTION

### Field of the Invention

The present invention relates to a laminate comprising at least two layers, wherein the first layer i) comprises at least one polyethylene polymer and the second layer ii) comprises at least one first elastomer (E1) and at least one second thermoplastic elastomer (E2). The present invention further relates to a layer composite molding comprising the laminate bonded to a fiber-reinforced plastic, to a process for producing the layer composite molding, to a wind turbine comprising the layer composite molding, and to the use of the laminate according to the invention in wind energy installations.

### Description of Related Art

Energy generation by means of wind energy installations has long been known. The rotor blades used in the wind energy installations are subject to considerable stresses during operation. These especially include wind pressure, erosion, for example by rain, insects or flying birds, seasonal and diurnal temperature fluctuations and UV insolation. Stress on rotor blades is particularly high in regions with a tropical climate as a result of varying weathering influences and especially as a result of the high air humidity. But even in temperate regions, such as Germany for example, there is a problem resulting from erosion of the rotor blades in operation of wind energy installations.

In operation of the wind energy installations, the rotor blades reach speeds of up to 300 km/h at their tips. As a result, particles and liquids present in the air, for example sand grains, salt particles, insects and other suspended particles, and raindrops have a wearing or abrasive effect. Especially in the leading edge region, the rotor blades are thus highly stressed and there is significant wear to the surface of the rotor blades at these places on the rotor blades, which causes loss of stability and aerodynamics of the rotor blades.

In order to reduce the wear and erosion of rotor blades in wind energy installations, the prior art has detailed various proposed solutions. In order to reduce the erosion of the rotor blades and the associated repair and maintenance work, it has been suggested, for example, that the speed of the rotor blades in the energy installations be reduced. This is disadvantageous, however, since a decrease in the speed of the rotor blades of a wind energy installation is associated with a reduction in power.

For that reason, the prior art has further proposed improving the erosion resistance of rotor blades in wind energy installations. In order to minimize the stresses, especially flexural stresses, acting on the bearings, any hubs and the tower of the wind energy installation, it is desirable for the rotor blades to be as light as possible.

For that reason, rotor blades and rotor blade elements are typically manufactured from fiber-reinforced plastics. For this purpose, fiber materials, such as fiber mats, are introduced into a rotor blade mold and impregnated with a resin composition which is subsequently cured. The introducing of fiber materials and the applying of the resin composition can be repeated to produce the rotor blade. Resin compositions used for rotor blades or other parts of wind turbine installations are frequently epoxy resin compositions that are cured subsequently, for example by heating. This affords composite moldings that can withstand relatively high mechanical stresses, combined with comparatively low weight.

In order to protect the rotor blades or rotor blade elements against erosion and weathering influences, it has been suggested in the prior art, for example, that films or layers of polyethylene be applied to the rotor blade or the rotor blade elements in order to achieve protection against erosion and weathering influences.

International Patent Application Publication WO 2017/068152 discloses a rotor blade having an outer layer which consists at least partly of polyethylene and which is bonded to a layer of a fiber-reinforced plastic via a further layer consisting at least partly of an elastomer and/or a polyurethane. The layer consisting at least partly of polyethylene and the layer consisting at least partly of elastomer and/or of polyurethane are combined to form a laminate composite and are subsequently bonded to the layer of the fiber-reinforced plastic.

The rotor blade disclosed in International Patent Application Publication WO 2017/068152 has good stability to erosion and weathering influences. There is nevertheless room for further improvements with regard to the erosion resistance of rotor blades and coatings for rotor blades.

### SUMMARY OF THE INVENTION

It is thus an object of the present invention to provide a laminate that enables an improvement in the erosion resistance of layer composite moldings, especially of rotor blades. The laminate and the layer composite moldings containing the laminate should additionally be producible easily and at minimum cost.

This object is achieved by a laminate comprising at least the layers i) and ii)
i) a first layer comprising at least one polyethylene polymer,
ii) a second layer comprising at least one first elastomer (E1) and at least one second elastomer (E2), where the at least one second elastomer (E2) is at least one thermoplastic elastomer selected from the group consisting of ethylene-α-olefin copolymers and styrene-alkylene block copolymers.

It has been found that, surprisingly, the use of the inventive combination of a first elastomer (E1) and the thermoplastic second elastomer (E2) in the second layer (ii) affords laminates having improved erosion resistance. Layer composite moldings in which the laminate according to the invention is bonded to a fiber-reinforced plastic layer additionally have improved adhesion between laminate and fiber-reinforced plastic layer. The process for producing the laminate according to the invention runs stably and, by comparison with the laminate production processes disclosed in the prior art, leads to a reduction in the production reject rate.

The present invention further provides a layer composite molding comprising the laminate according to the invention in which the laminate has been bonded to a fiber-reinforced plastic, where the first layer i) of the laminate forms an outer face of the layer composite molding and the second layer ii) of the laminate faces the fiber-reinforced plastic.

The present invention further provides a wind turbine comprising the layer composite molding according to the invention.

The present invention further provides a process for producing a layer composite molding, comprising the steps of
I) producing or providing the laminate according to the invention
II) combining the laminate produced or provided with the fiber-reinforced plastic.

### DETAILED DESCRIPTION OF THE INVENTION

### Laminate Comprising Layers i) and ii)

The laminate comprises at least the two layers i) and ii).

What is meant by the expression “at least two layers i) and ii)” with regard to the laminate in the context of the present invention is exactly two layers i) and ii), and also three or more layers, that are present in the laminate. The expressions “at least two layers i) and ii)” and “two layers i) and ii)” are used synonymously in the context of the present invention.

If the laminate, as well as layers i) and ii), comprises one or more further layers, these layers may be disposed on top of layer i), below second layer ii) and/or between layers i) and ii).

In a preferred embodiment, in the laminate according to the invention, the first layer i) is disposed directly atop the second layer ii). What is meant by “directly atop” in the present context is that there are no further layers between the first layer i) and the second layer ii).

In a particularly preferred embodiment, the laminate consists of the first layer i) and the second layer ii). This means that the laminate does not contain any further layers aside from the first layer i) and the second layer ii).

### First Layer i)

The first layer i) preferably forms the top face of the laminate. The first layer i) contains at least one polyethylene polymer.

The expression “at least one polyethylene polymer” in the context of the present invention means exactly one polyethylene polymer and mixtures of two or more polyethylene polymers. The terms “at least one polyethylene polymer” and “a polyethylene polymer” are used synonymously in the context of the present invention.

In a preferred embodiment, the first layer i) contains exactly one polyethylene polymer.

Suitable polyethylene polymers are preferably high molecular weight polyethylene (HMW-PE), ultrahigh molecular weight polyethylene (UHMW-PE) and/or polytetrafluoroethylene (PTFE).

Particularly preferred polyethylene polymers are high molecular weight polyethylene (HMW-PE) and ultrahigh molecular weight polyethylene. Ultrahigh molecular weight polyethylene is especially preferred.

The present invention therefore further provides a laminate comprising, in the first layer i), at least one polyethylene polymer selected from the group consisting of high molecular weight polyethylene (HMW-PE), ultrahigh molecular weight polyethylene (UHMW-PE) and polytetrafluoroethylene (PTFE).

In the context of the present invention, a high molecular weight polyethylene (HMW-PE) is understood to mean a polyethylene polymer having an average molar mass of 500 to less than 1000 kg/mol.

An ultrahigh molecular weight polyethylene (UHMW-PE) in the context of the present invention is understood to mean a polyethylene polymer having an average molar mass of at least 1000 kg/mol.

Preference is given in the context of the present invention to ultrahigh molecular weight polyethylenes (UHMW-PE) having an average molar mass in the range from 1000 kg/mol to 11 000 kg/mol, more preferably having an average molar mass in the range from 3000 kg/mol to 10 200 kg/mol, especially preferably having an average molar mass in the range from 5000 kg/mol to 10 000 kg/mol. The average molar mass is determined by calculation via the Margolies equation. The polyethylene polymer according to the invention may be linear, partly crosslinked or crosslinked.

The ultrahigh molecular weight polyethylene used (without fillers) preferably has a density in the range from 0.91 to 0.95 g/cm³.

In particular, the ultrahigh molecular weight polyethylene (UHMW-PE) is notable for very good wear properties and abrasion properties even in the case of abrasive media. The use of ultrahigh molecular weight polyethylene (UHMW-PE) in the first layer i) can significantly improve the wear resistance and abrasion resistance of the laminate according to the invention and the layer composite molding produced therefrom, especially of rotor blades.

In a preferred embodiment, the first layer i) present in the laminate, based on 100 parts by weight of the total amount of the at least one polyethylene polymer present in the first layer i), contains not more than 10 parts by weight of further components (K1).

The present invention therefore also provides a laminate in which the first layer i), based on 100 parts by weight of the total amount of the at least one polyethylene polymer present in the first layer i), contains not more than 10 parts by weight of further components (K1).

The further components (K1) present in the first layer i) may, for example, be one or more UV stabilizer(s). Preferred UV stabilizers are organic and inorganic UV absorbers.

Preferred UV stabilizers are selected, for example, from the list comprising benzophenones, benzotriazoles, oxalanilides, phenyltriazines, carbon black, titanium dioxide, iron oxide pigments and zinc oxide, or 2,2,6,6-tetramethylpiperidine derivatives such as bis(2,2,6,6-tetramethyl-4-piperidyl) sebacate (“hindered amine light stabilizer (HALS)”).

The presence of a UV stabilizer can increase the long-term stability of the laminate to UV light.

### Second Layer ii)

The second layer ii) preferably forms the underside of the laminate. The second layer ii) contains at least one first elastomer (E1) and at least one second elastomer (E2), where the at least one second elastomer (E2) is at least one thermoplastic elastomer selected from the group consisting of ethylene-α-olefin copolymers and styrene-alkylene block copolymers.

What is meant by the expression “at least one first elastomer (E1)” in the context of the present invention is exactly one first elastomer (E1) and mixtures of two or more first elastomers (E1). The expressions “at least one first elastomer (E1)” and “a first elastomer (E1)” are used synonymously in the context of the present invention.

In a preferred embodiment, the second layer ii) contains exactly one first elastomer (E1).

Elastomers suitable as the first elastomer (E1) are, for example, ethylene-propylene polymer (EPM), ethylene-propylene-diene polymer (EPDM), ethylene-acrylate polymer (EAM), fluorocarbon polymer (FKM), acrylate polymer (ACM), ethylene-vinyl acetate polymer (EVA) and/or acrylonitrile-butadiene polymer (NBR).

The present invention therefore also provides a laminate in which the at least one first elastomer (E1) present in the second layer ii) is at least one elastomer selected from the group consisting of ethylene-propylene polymer (EPM), ethylene-propylene-diene polymer (EPDM), ethylene-acrylate polymer (EAM), fluorocarbon polymer (FKM), acrylate polymer (ACM), ethylene-vinyl acetate polymer (EVA) and acrylonitrile-butadiene polymer (NBR).

The first elastomer (E1) is preferably non-thermoplastic. In a preferred embodiment, the first elastomer (E1) in the second layer ii) in the laminate is in crosslinked form. Crosslinking agents used for production of the at least one first elastomer (E1) in crosslinked form may be any of the crosslinking agents known to the person skilled in the art.

Preferred crosslinking agents are, for example, sulfur and/or peroxide-based crosslinking agents, particular preference being given to peroxide-based crosslinking agents.

Peroxide-based crosslinking agents are known to those skilled in the art. Examples of these are organic peroxides, e.g. alkyl and aryl peroxides, alkyl peresters, aryl peresters, diacyl peroxides, polyvalent peroxides such as 2.5-dimethyl-2,5-di(tert-butylperoxy)hex-3-yne (e.g. Trigonox® 145-E85 or Trigonox® 145-45 B), di-tert-butyl peroxide (e.g. Trigonox® B), 2,5-dimethyl-2.5-di(tert-butylperoxy)hexane (e.g. Trigonox® 101), tert-butyl cumyl peroxide (e.g. Trigonox® T), di(tert-butyl-peroxyisopropyl)benzene (e.g. Perkadox® 14-40), dicumyl peroxide (e.g. Perkadox® BC40), 2.2-bis(tert-butylperoxy)diisopropylbenzene (e.g. Volcup® 40 AE), 3,2,5-trimethyl-2,5-di(benzoylperoxy)hexane and (2,5-bis(tert-butylperoxy)-2,5-dimethyl-hexane, butyl 4,4′-di(tert-butylperoxy)valerate, 1,1′-bis(tert-butylperoxy)-3,3,5-trimethylcyclohexane, 3,3,5,7,7-pentamethyl-1,2,4-trioxepane (e.g. Trigonox® 311), tert-butyl peroxybenzoate and tert-butyl peroxy-2-ethylhexylcarbonate.

Peroxide-based crosslinking agents used may, for example, be at least one crosslinking agent selected from the group consisting of di(tert-butylperoxyisopropyl)benzene, 2,5-dimethyl-2,5-bis(tert-butyl)peroxy)hexane, dicumyl peroxide, di(tert-butyl) peroxide, butyl 4,4′-di(tert-butylperoxy)valerate, 1,1′-bis(tert-butylperoxy)-3,3,5-trimethylcyclohexane, tert-butyl cumyl peroxide, tert-butyl peroxybenzoate and tert-butyl peroxy-2-ethylhexylcarbonate.

Particularly preferred peroxide-based crosslinking agents are 1,1-bis(tert-butylperoxy)-3,3,5-trimethylcyclohexane and 2,5-dimethyl-2,5-di(tert-butylperoxy)hexane.

A first elastomer (E1) used is more preferably ethylene-propylene-diene polymer (EPDM) and/or ethylene-vinyl acetate polymer (EVA).

Suitable ethylene-propylene-diene polymers (EPDM) generally have a Mooney viscosity (measured to ISO 289; ML (1+4) 125° C.) in the range from 20 to 130 MU, preferably in the range from 40 to 110 MU and more preferably in the range from 60 to 90 MU.

Suitable ethylene-propylene-diene polymers (EPDM) generally have an ethylene content (measured to ASTM D 3900) in the range from 40% to 80% by weight, preferably in the range from 42% to 70% by weight and more preferably in the range from 45% to 60% by weight.

What is meant by the expression “at least one second elastomer (E2)” in the context of the present invention is exactly one second elastomer (E2) and mixtures of two or more second elastomers (E2). The expressions “at least one second elastomer (E2)” and “a second elastomer (E2)” are used synonymously in the context of the present invention.

In a preferred embodiment, the second layer ii) contains exactly one second elastomer (E2).

The second elastomer (E2) is thermoplastic. In the context of the present application, a thermoplastic elastomer is understood to mean an elastomer which has properties similar to those of vulcanized rubber at its use temperature, but which can be worked and processed like a thermoplastic at elevated temperatures.

The at least one second elastomer (E2) present in the second layer ii) of the laminate is an ethylene-α-olefin copolymer and/or a styrene-alkylene block copolymer.

There follows a detailed description of the ethylene-α-olefin copolymer. The styrene-alkylene block copolymer is described in detail further down.

Ethylene-α-olefin copolymers are known from the prior art. They may take the form of random copolymers or of block copolymers and have good flexibility and good elasticity.

Preference is given to using ethylene-α-olefin block copolymers. Ethylene-α-olefin block copolymers generally have good heat resistance, a high melting point, good compression set and good elasticity. Ethylene-α-olefin block copolymers may additionally be processed by injection molding and extruded to sheets, foils and films.

Preference is given in accordance with the invention to the use of ethylene-α-olefin block copolymers that are essentially free of olefinically unsaturated double bonds.

Preference is likewise given in accordance with the invention to the use of ethylene-α-olefin block copolymers in the form of a linear multiblock copolymer composed of polyethylene blocks and poly-α-olefin blocks.

In the context of the present invention, an ethylene-α-olefin block copolymer is preferably understood to mean a multiblock copolymer which is produced by polymerization of at least two different monomers.

The at least two different monomers are the ethylene monomer (also referred to as ethene) and an α-alkene monomer other than ethylene (the different monomers are also referred to hereinafter in relation to the ethylene-α-olefin block copolymer as “repeat units”).

The ethylene-α-olefin block copolymer is produced using, as well as ethylene, one, two or more different α-alkene monomers.

A multiblock copolymer is understood to mean a polymer having two or more chemically different regions or segments (also referred to as “blocks”) that are bonded to one another preferably in a linear manner, i.e. a polymer having chemically different blocks bonded end-to-end. In a preferred embodiment, the blocks are different with regard to the amount or type of the α-alkene monomer (other than ethylene) used therein, the density of the crystalline component, the crystal size, the type or degree of tacticity (isotactic or syndiotactic), the degree of branching, homogeneity and/or other chemical or physical parameters.

The multiblock copolymer may preferably be constructed according to the following formula:

(AB)ₙ

where n is at least 1, preferably an integer greater than 1, for example 2, 3, 4, 5, 10, 15, 20, 30, 40, 50, 60, 70, 80, 90, 100 or higher.

In addition, the ethylene-α-olefin block copolymers may also be triblock copolymers according to the following formula:

ABA

“A” in the above formulae represents a hard segment and “B” represents a soft segment of the ethylene-α-olefin block copolymer. Segments A and B are preferably joined to one another in a linear manner. Segments A and B are more specifically described hereinafter.

Segments A and B are preferably distributed randomly along the polymer chain. In other words, the multiblock copolymer (ethylene-α-olefin block copolymer) does not usually have the structure AAA-AA-BBB-BB.

In a preferred embodiment, the multiblock copolymers (ethylene-α-olefin block copolymers) do not have a third type of block in addition to segments A and B. Each of the A and B segments preferably has randomly distributed repeat units.

The ethylene-α-olefin block copolymer preferably has repeat units that derive from ethylene (repeat ethylene units) in a majority.

This means that the ethylene-α-olefin block copolymer, based on the total number of repeat units of the ethylene-α-olefin block copolymer, contains preferably at least 50 mol %, more preferably at least 60 mol %, even more preferably at least 70 mol % and most preferably at least 80 mol % of repeat ethylene units.

The ethylene-α-olefin block copolymer preferably has repeat units that derive from α-alkene monomer(s) (α-alkene monomer repeat units) in a minority.

This means that the ethylene-α-olefin block copolymer, based on the total number of repeat units in the ethylene-α-olefin block copolymer, contains preferably in the range from 10 mol % to 20 mol %, more preferably in the range from 15 mol % to 20 mol %, of repeat α-alkene monomer units.

The content of various repeat units in the ethylene-α-olefin block copolymer can be determined by means of nuclear magnetic resonance (NMR).

A “hard” segment A is preferably understood to mean polymer blocks in which repeat ethylene units are present preferably in an amount of greater than 95% by weight, more preferably in an amount of greater than 98% by weight, based on the total weight of the polymer block (of the hard segment A in the ethylene-α-olefin block copolymer).

In other words, the content of repeat α-alkene monomer units in the hard segments A is preferably less than 5% by weight, more preferably less than 2% by weight, based on the total weight of segment A in the ethylene-α-olefin block copolymer.

In some embodiments, the hard segment A is formed entirely from ethylene.

A “soft” segment B is preferably understood to mean polymer blocks in which repeat α-alkene monomer units are present preferably in an amount of greater than 5% by weight, more preferably in an amount of greater than 8% by weight, even more preferably in an amount of greater than 10% by weight and most preferably in an amount of greater than 15% by weight, based on the total weight of the polymer block (of the soft segment B in the ethylene-α-olefin block copolymer).

In some embodiments, the content of repeat α-alkene monomer units in the soft segment B is greater than 20% by weight, more preferably greater than 25% by weight, even more preferably greater than 30% by weight, yet more preferably greater than 35% by weight, yet more preferably greater than 40% by weight, yet more preferably greater than 45% by weight, yet more preferably greater than 50% by weight and especially preferably greater than 60% by weight, based on the total weight of the soft segment B in the ethylene-α-olefin block copolymer.

The soft segments B are present in the multiblock copolymer (the ethylene-α-olefin block copolymer) preferably in a proportion of 1% by weight to 99% by weight, of 5% by weight to 95% by weight, of 10% by weight to 90% by weight, of 15% by weight to 85% by weight, of 20% by weight to 80% by weight, of 25% by weight to 75% by weight, of 30% by weight to 70% by weight, of 35% by weight to 65% by weight, of 40% by weight to 60% by weight, of 45% by weight to 55% by weight, based on the total weight of the ethylene-α-olefin block copolymer.

Conversely, the hard segments A may be present within the same ranges, in which case the sum total of the percentages by weight of the hard segments A and the soft segments B in the ethylene-α-olefin block copolymer preferably adds up to 100% by weight.

The proportions by weight of soft segment B and hard segments A in the ethylene-α-olefin block copolymer may be calculated on the basis of data that are obtained from differential scanning calorimetry (DSC) or nuclear magnetic resonance (NMR).

The ethylene-α-olefin block copolymers preferably have a density in the range from 0.86 g/cm³ to 0.91 g/cm³. The molecular weight distribution Mw/Mn, also referred to as polydispersity Q, in the case of the ethylene-α-olefin block copolymers is preferably within a range from 1.5 to 8.0, more preferably within a range from 1.7 to 3.5. The weight-average molecular weight Mw of the ethylene-α-olefin block copolymers is preferably within a range from 10 000 to 2 500 000 g/mol, more preferably from 20 000 to 500 000 g/mol and most preferably from 20 000 to 350 000 g/mol. The weight-average molecular weight Mw and the molecular weight distribution Mw/Mn are preferably determined by gel permeation chromatography (GPC).

Suitable ethylene-α-olefin block copolymers generally have a Mooney viscosity (measured to ASTM D1646; ML 1+4 121ºC) in the range from 2 to 55 MU, preferably in the range from 5 to 40 MU and more preferably in the range from 6 to 25 MU.

The ethylene-α-olefin block copolymers used with preference in accordance with the invention are preferably polymers that derive from the monomers: ethylene and at least one C₃-C₂₀-α-alkane.

Preference is given to ethylene-α-olefin block copolymers obtainable by polymerization of ethylene with at least one of the α-alkene monomers that follow, such as for example α-monounsaturated compounds, such as α-monounsaturated C₃-C₂₀ aliphatic compounds, or aromatic compounds having a monounsaturated radical, such as a vinyl unit, in the α position.

The α-monounsaturated C₃-C₂₀ aliphatic compounds may be straight-chain, branched or cyclic compounds. Examples of preferred α-monounsaturated compounds or aromatic compounds having a monounsaturated radical are as follows:
propylene, isobutylene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 3-methyl-1-butene, 3-methyl-1-pentene, 4-methyl-1-pentene, 4,6-dimethyl-1-heptene, vinylcyclohexane, ethylidenenorbornene, cyclobutene, cyclopentene, cyclohexene, cyclooctene, styrene, o-methylstyrene, p-methylstyrene, t-butylstyrene and the like. Particularly preferred 1-olefins are propylene, 1-butene, 1-pentene, 1-hexene, 1-octene or a combination thereof, particular preference being given to 1-butene and 1-octene.

In one embodiment, it is preferable to use ethylene-α-olefin block copolymers that are essentially free of olefinically unsaturated double bonds. In this case, the molar proportion of olefinically unsaturated double bonds is preferably less than 0.5 mol %, more preferably less than 0.1 mol % and especially preferably less than 0.01 mol %, based on the number of moles of all monomer units used for polymerization in the ethylene-α-olefin block copolymer.

Even more preferably, the ethylene-α-olefin block copolymer does not contain any olefinically unsaturated double bonds. Most preferably, the ethylene-α-olefin block copolymer is composed solely of repeat units that originate from the polymerization of ethylene and monounsaturated C₃-C₂₀-α-alkenes.

Particularly preferred ethylene-α-olefin block copolymers present as the second elastomer ii) in the second layer of the laminate are those that are obtained by polymerization of ethylene with propylene, 1-butene, 1-pentene, 1-hexene and/or 1-octene, particular preference being given to 1-butene and 1-octene.

The above-described ethylene-α-olefin block copolymers are available, for example, under the INFUSE® or ENGAGE® brand names from The Dow Chemical Company.

In a particularly preferred embodiment, the thermoplastic second elastomer (E2) present in the second layer ii) of the laminate according to the invention is at least one ethylene-α-olefin block copolymer selected from the group consisting of ethylene-1-butene block copolymer and ethylene-1-octene block copolymer.

An especially preferred second elastomer (E2) is ethylene-1-octene block copolymer.

The styrene-alkylene block copolymer is described in detail hereinafter.

It is also possible to use styrene-alkylene block copolymers as the second elastomer (E2). The styrene-alkylene block copolymer is preferably a triblock copolymer in which the two terminal blocks are formed from polystyrene and the middle block from a polymer other than polystyrene. It is preferable here that the middle block of the triblock copolymer is formed by a polyolefin.

The styrene-alkylene block copolymer is preferably at least one polymer selected from the group consisting of styrene-ethylene-butylene-styrene block copolymer (SEBS), styrene-ethylene-propylene-styrene block copolymer (SEPS), styrene-ethylene-ethylene-propylene-styrene block copolymer (SEEPS) and styrene-isoprene-styrene block copolymer (SIS).

The present invention therefore also provides a laminate in which the second elastomer (E2) present in the second layer ii) is selected from the group consisting of styrene-ethylene-butylene-styrene block copolymer (SEBS), styrene-ethylene-propylene-styrene block copolymer (SEPS), styrene-ethylene-ethylene-propylene-styrene block copolymer (SEEPS) and styrene-isoprene-styrene block copolymer (SIS).

It is further preferable that the styrene-alkylene block copolymer is not functionalized with an anhydride of an organic acid, a vinylalkoxysilane, a vinylacyloxysilane, a methacryloyloxyalkylalkoxysilane or a methacryloyloxyalkylacyloxysilane. More preferably, the styrene-alkylene block copolymer is one not grafted with an anhydride of an unsaturated organic acid, a vinylalkoxysilane, a vinylacyloxysilane, a methacryloyloxyalkylalkoxysilane or a methacryloyloxyalkylacyloxysilane. The styrene-alkylene block copolymer is preferably not a grafted styrene-alkylene block copolymer. The styrene-alkylene block copolymer is preferably not a functionalized styrene-alkylene block copolymer.

According to the invention, the term “styrene-alkylene block copolymer” is understood to mean a multiblock copolymer where at least one of the blocks is polystyrene.

The styrene-alkylene block copolymer may be a triblock copolymer of the A′-B′-A′ structure where the A′ block is typically polystyrene and the B′ block is typically formed from polyethylene, polypropylene, polybutylene and/or polyisoprene.

Alternatively, in the A′ block, the styrene monomers may be replaced partly or fully by derivatives of styrene, for example α-methylstyrene, 2-methylstyrene, 3-methylstyrene, 4-methylstyrene, 4-tert-butylstyrene, 4-cyclohexylstyrene and/or vinylnaphthalenes such as 1-vinylnaphthalene and 2-vinylnaphthalene.

As well as triblock copolymers, it is alternatively also possible to use diblock, tetrablock or multiblock copolymers of the recited monomers of styrene, styrene derivatives (A′ blocks) and the aforementioned B′ blocks in a different sequence of A′ and B′ blocks (for example B′-A′-B′-A′, A′B′-A′B′, etc.). Preferred styrene-alkylene block copolymers have the structure of a triblock copolymer A′-B′-A′.

Inventive styrene-alkylene block copolymers preferably have a weight-average molar mass (Mw) of 50 000 to 1 000 000 g/mol, more preferably of 100 000 to 500 000 g/mol.

In a preferred embodiment, the styrene-alkylene block copolymer is essentially free of olefinically unsaturated double bonds. In this case, the molar proportion of olefinically unsaturated double bonds is preferably less than 0.5 mol %, more preferably less than 0.1 mol % and especially preferably less than 0.01 mol %, based on the number of moles of all monomer units of the styrene-alkylene block copolymer used for the polymerization. Such styrene-alkylene block copolymers are also referred to as hydrogenated styrene-alkylene block copolymers.

The second elastomer (E2) in the second layer ii) in the laminate is preferably in at least partly crosslinked form, more preferably in fully crosslinked form. Crosslinking agents used for production of the at least one second elastomer (E2) in crosslinked form may be any of the crosslinking agents known to the person skilled in the art. Preference is given to peroxide-based crosslinking agents, where the observations and preferences expressed above with regard to the first elastomer (E1) are correspondingly applicable.

More preferably, both the at least one first elastomer (E1) and the at least one second elastomer (E2) are in crosslinked form in the second layer ii) of the laminate. Preferably, the at least one first elastomer (E1) in crosslinked form and the at least one second elastomer (E2) in crosslinked form are produced by the use of the same crosslinking agent.

Preference is given to a laminate in which the at least one second elastomer (E2) present in the second layer ii) is selected from the group consisting of ethylene-α-C₃-C₂₀-alkylene copolymer, styrene-ethylene-butylene-styrene block copolymer (SEBS), styrene-ethylene-propylene-styrene block copolymer (SEPS), styrene-ethylene-ethylene-propylene-styrene block copolymer (SEEPS) and styrene-isoprene-styrene block copolymer (SIS), particular preference being given to the ethylene-α-C₃-C₂₀-alkene copolymer.

Particular preference is given to a laminate containing, in the second layer ii), an ethylene-propylene-diene polymer (EPDM) as the first elastomer (E1) and an ethylene-α-C₃-C₂₀-alkene copolymer as the second elastomer (E2), where a preferred second elastomer (E2) is an ethylene-1-octene block copolymer.

The weight ratio of first elastomer (E1) to second elastomer (E2) in the second layer ii) of the laminate is preferably in the range from 10:90 to 90:10, more preferably in the range from 30:70 to 70:30 and especially in the range from 40:60 to 60:40.

Preferably, the second layer ii) present in the laminate, based on 100 parts by weight of the total amount of the elastomers (E1) and (E2) present in the second layer, contains not more than 200 parts by weight, more preferably not more than 135 parts by weight, of further components (K2).

The present invention thus further provides a laminate in which the second layer ii), based on 100 parts by weight of the total amount of the elastomers (E1) and (E2) present in the second layer, contains not more than 200 parts by weight of further components (K2).

Suitable further components (K2) with regard to the second layer ii) of the laminate are, for example, additives, plasticizers and fillers.

Suitable additives are selected, for example, from the group consisting of ageing stabilizers, processing auxiliaries, colour pigments, blowing agents, flame retardants, adhesion promoters, lubricants and demolding aids.

Suitable fillers are selected, for example, from the group consisting of carbon blacks and mineral fillers such as silica, kaolins, chalk, siliceous chalk, aluminium trihydrates, magnesium hydroxides, barium sulfate, talc, kieselguhr and zeolites.

Processes for producing the laminate containing the first layer i) and the second layer ii) are known to those skilled in the art.

For production of the laminate according to the invention, the first layer i) is preferably provided in the form of a first web (Bi) having a width in the range from 40 to 150 cm, preferably from 60 to 120 cm, especially preferably from 80 to 100 cm.

The thickness of the first layer i) provided in the form of a first web (Bi) is preferably in the range from 0.2 to 2.5 mm, preferably from 0.4 to 1.5 mm, especially preferably from 0.5 to 1.0 mm.

For the first web (Bi), the observations and preferences expressed above with regard to the first layer i) are correspondingly applicable.

For production of the first web (Bi), the at least one polyethylene polymer is compounded if appropriate with the further components (K1). The compounding can be effected in standard mixing apparatus. The compound (C1) thus obtained can subsequently be processed in suitable apparatuses, for example by molding, sintering and/or skiving, to give the first web (Bi).

For production of the laminate, in addition, the second layer ii) is preferably provided in the form of a second web (Bii) having a width in the range from 40 to 150 cm, preferably from 60 to 120 cm, especially preferably from 80 to 100 cm.

The thickness of the second layer ii) provided in the form of a second web (Bii) is preferably in the range from 0.2 to 2.5 mm, preferably from 0.3 to 1.5 mm, especially preferably from 0.5 to 1.0 mm.

The elastomers (E1) and (E2) present in the second web (Bii) may be in uncrosslinked or crosslinked form.

Preferably, the elastomers (E1) and (E2) present in the second web (Bii) are in uncrosslinked form. In this embodiment, the web (Bii) contains at least one crosslinking agent, where the descriptions and preferences given above with regard to the crosslinking agent are correspondingly applicable. The second web (Bii) preferably contains a peroxide-based crosslinking agent, especially preferably 1,1-bis(tert-butylperoxy)-3,3,5-trimethylcyclohexane.

For production of the second web (Bii), the at least one first elastomer (E1) and the at least one second elastomer (E2), if appropriate together with the above-described components (K2), are preferably processed to a compound (C₂). The compound (C₂) can be produced in known mixing apparatus, such as kneader-mixers. The compound (C₂) thus produced can subsequently be processed to give the second web (Bii). Suitable apparatus for this purpose is, for example, calenders and extruders.

If the second web (Bii) contains the elastomers (E1) and (E2) in uncrosslinked form, compound (C₂) additionally contains at least one crosslinking agent, in which case the observations and preferences expressed above are correspondingly applicable here too.

The first web (Bi) provided and the second web (Bii) provided are subsequently joined to form the laminate. Suitable apparatus for this purpose is, for example, automatic mat vulcanization systems (AUMA) and hot press systems.

In a preferred embodiment, the second web (Bii) contains the two elastomers (E1) and (E2) in uncrosslinked form. In this case, the elastomers (E1) and (E2) present in the second web (Bii) are crosslinked with the first web (Bi) during or after the joining in order to obtain the laminate.

This embodiment is preferred since this gives optimal adhesion between the first layer i) and the second layer ii) in the laminate. The elastomers (E1) and (E2) obtained in the second web (Bii) are crosslinked by commonly known methods by supply of energy, preferably by the supply of heat.

### Layer Composite Molding Comprising the Laminate

The present invention further provides a layer composite molding comprising the laminate, wherein the laminate is bonded to a fiber-reinforced plastic and wherein the first layer i) of the laminate forms the outer face of the layer composite molding and the second layer ii) of the laminate faces the fiber-reinforced plastic.

The first layer i) of the laminate thus preferably forms the outer face of the layer composite molding, which is adjoined, preferably directly, by the second layer ii) of the laminate in the direction from the outside to the inside. The side of the second layer ii) of the laminate which is remote from the first layer i) of the laminate is adjoined by the fiber-reinforced plastic in the layer composite molding.

Further layers may be disposed between the second layer ii) of the laminate and the fiber-reinforced plastic of the layer composite molding.

It is also possible that the second layer ii) of the laminate is directly bonded to the fiber-reinforced plastic.

In a preferred embodiment, a third layer iii) is disposed between the second layer ii) of the laminate and the fiber-reinforced plastic of the layer composite molding. The third layer iii) preferably comprises at least one adhesive selected from the group consisting of polyurethane adhesives, methyl (meth)acrylate adhesives and epoxy adhesives.

The present invention thus also provides a layer composite molding in which the laminate is bonded to the fiber-reinforced plastic by a third layer iii) containing at least one adhesive selected from the group consisting of polyurethane adhesives, methyl (meth)acrylate adhesives and epoxy adhesives.

The fiber-reinforced plastic, in a preferred embodiment, includes fibers selected from the group consisting of ultrahigh molecular weight polyethylene fibers (UHMW-PE fibers), carbon fibers and glass fibers, particular preference being given to glass fibers.

The invention thus also further provides a layer composite molding in which the fiber of the fiber-reinforced plastic is at least one fiber selected from the group consisting of ultrahigh molecular weight polyethylene fibers (UHMW-PE fibers), carbon fibers and glass fibers.

The plastic of the fiber-reinforced plastic is preferably selected from the group of plastics consisting of epoxy-based, copolyurethane-based, poly(meth)acrylate-based, polymethyl (meth)acrylate-based and poly(meth)acrylamide-based plastics.

The present invention therefore also further provides a layer composite molding in which the plastic of the fiber-reinforced plastic is at least one epoxy-based, polyurethane-based, poly(meth)acrylate-based, polymethyl (meth)acrylate-based or poly(meth)acrylamide-based plastic.

The layer composite molding is produced by methods known to the person skilled in the art. Typically, for this purpose, in the shaping process, the fiber-reinforced plastic is first provided. Subsequently, the laminate according to the invention is applied to the surface of the fiber-reinforced plastic thus provided and bonded to the surface. The fiber-reinforced plastic here may be in cured or uncured form.

If the fiber-reinforced plastic is provided in uncured form, the laminate may be applied directly, i.e. without the use of a third layer iii). The curing of the fiber-reinforced plastic then achieves binding between the second layer ii) of the laminate and the top side of the fiber-reinforced plastic.

In a further embodiment, the fiber-reinforced plastic is already provided in cured form. In this embodiment, it may be advantageous to position the above-described third layer iii) between the second layer ii) of the laminate and the top side of the fiber-reinforced plastic, in order to ensure good adhesion between the laminate and the fiber-reinforced plastic.

The laminate according to the invention and the layer composite molding according to the invention that contains the laminate are notable for excellent weathering resistance and erosion resistance. They are therefore of good suitability for use in wind power installations.

The present invention therefore also further provides a rotor blade containing the laminate. The invention further provides a rotor blade containing the layer composite molding according to the invention. The present invention additionally further provides a layer composite molding which is a rotor blade.

The present invention is illustrated in detail by the examples that follow, but without being limited thereto.

### EXAMPLES

The following laminates were produced and examined:

### Comparative Example

A first layer i) used was an ultrahigh molecular weight polyethylene polymer having an average molar mass of 8700 kg/mol and a density of 0.93 g/cm³.

For the second layer ii), an elastomer composition (VE) from the prior art was used, which was obtained by crosslinking the following composition:

Parts by weight [phr]
50 EPDM (CAS No. 25038-36-2) having a Mooney viscosity of 80 MU (measured to ISO 289; ML (1+4) 125° C.), an ethylene content (measured to ASTM D 3900) of 48% by weight and a density of 0.86 g/cm³
50 EPDM (CAS No. 25038-36-2) having a Mooney viscosity of 25 MU (measured to ISO 289; ML (1+4) 125° C.), an ethylene content (measured to ASTM D 3900) of 53% by weight and a density of 0.86 g/cm³
0.1 carbon black (CAS No. 1333-86-4)
50 silica (CAS No. 7631-86-9)
35 paraffin oil (CAS No. 64742-54-7)
1.6 UV stabilizer (CAS No. 202483-55-4)
0.1 inhibitor (CAS No. 88-27-7)
3 titanium dioxide (CAS No. 13463-67-7)
15 coagent for crosslinking (CAS No. 3290-92-4)
5 peroxide crosslinking agent (CAS No. 6731-36-8)

### Inventive Example

The first layer i) used was an ultrahigh molecular weight polyethylene polymer having an average molar mass of 8700 kg/mol and a density of 0.93 g/cm³.

For the second layer ii), an elastomer composition (EE) was used that was obtained by crosslinking the following composition:

Parts by weight [phr]
40 EPDM (CAS No. 25038-36-2) having a Mooney viscosity of 80 MU (measured to ISO289; ML (1+4) 125° C.), an ethylene content (measured to ASTM D 3900) of 48% by weight and a density of 0.86 g/cm³
60 ethylene-1-octene block copolymer (CAS No. 26221-73-8) having a Mooney viscosity of 8 MU (measured to ASTM D1646; ML 1+4 121° C.) and a density of 0.87 g/cm³.
0.1 carbon black (CAS No. 1333-86-4)
50 silica (CAS No. 7631-86-9)
45 paraffin oil (CAS No. 64742-54-7)
1.6 UV stabilizer (CAS No. 202483-55-4)
0.1 inhibitor (CAS No. 88-27-7)
3 titanium dioxide (CAS No. 13463-67-7)
10 coagent for crosslinking (CAS No. 3290-92-4)
8 peroxide crosslinking agent (CAS No. 6731-36-8)

The elastomer composition (VE) from the comparative example and the above-described ultrahigh molecular weight polyethylene polymer were used to produce a laminate (comparative laminate VL) known from the prior art.

In addition, the elastomer composition (EE) from the inventive example and the above-described ultrahigh molecular weight polyethylene polymer were used to produce a laminate according to the invention (inventive laminate EL).

The comparative laminate (VL) and the inventive laminate (EL) were used to conduct rain erosion tests according to international standard DNVGL-RP-0171 (Testing of rotor blade erosion protection systems).

For this purpose, three comparative layer composite moldings (VFT1, VFT2 and VFT3) and three inventive layer composite moldings (EFT1, EFT2 and EFT3) were produced, in each case using a glass fiber-reinforced epoxy infusion resin as fiber-reinforced plastic, to which the respective laminates (VFT/EFT) were then applied by adhesive bonding by means of an epoxy adhesive.

The test apparatus used was a rain erosion tester by R&D Test Systems a/s.

The rain erosion tests were conducted
under the following conditions:

| Test parameter | Unit | Value |
|---|---|---|
| Test duration | [min] | 540 (VFT); 960 (EFT) |
| Impact speed in the centre | [m/s] | 125.5 |
| of the test body | | |
| Water temperature | [° C.] | 2 |
| Water quality | [μS/cm] | 2 |
| Test chamber temperature | [° C.] | 2 |
| Test chamber pressure | [Pa] | 2 |
| Average droplet diameter | [mm] | 2.5662 +/− 13.3% |
| Rain intensity in exposure | [m/s] | 8.707 × 10⁻⁶ |
| zone | | |
| Max. impact speed | [m/s] | 149.9 |
| Min. impact speed | [m/s] | 101.1 |
| Specif. impact frequency per | [impact/ | 50 364 |
| unit time in exposure zone | m² × s] | |

The samples were examined visually every 30 minutes. The results for the rain erosion tests are reported in the table below.

Comparative layer composite moldings (VFT1, VFT2 and VFT3)

| Test parameter | Unit | Value |
|---|---|---|
| Fault mode | [—] | Erosion |
| Start of erosion | [min] | VFT1: 60 |
| | | VFT2: 60 |
| | | VFT3: 90 |
| Breakthrough of | [min] | VFT1: 480 |
| erosion | | VFT2: 450 |
| | | VFT3: 480 |

Inventive layer composite moldings (EFT1, EFT2 and EFT3)

| Test parameter | Unit | Value |
|---|---|---|
| Fault mode | [—] | Erosion |
| Start of erosion | [min] | EFT1: 150 |
| | | EFT2: 120 |
| | | EFT3: 120 |
| Breakthrough of | [min] | EFT1: 930 |
| erosion | | EFT2: 840 |
| | | EFT3: 840 |

The rain erosion tests show that the inventive laminates lead to a significant improvement in the erosion resistance of layer composite moldings such as rotor blades.

What is claimed is:

1. A laminate comprising at least layers i) and ii):
i) a first layer comprising at least one polyethylene polymer, and
ii) a second layer comprising at least one first elastomer (E1) and at least one second elastomer (E2), where the at least one second elastomer (E2) is at least one thermoplastic elastomer selected from the group consisting of ethylene-α-olefin copolymers and styrene-alkylene block copolymers.

2. The laminate according to claim 1, wherein the at least one polyethylene polymer present in the first layer i) is at least one polyethylene polymer selected from the group consisting of high molecular weight polyethylene (HMW-PE), ultrahigh molecular weight polyethylene (UHMW-PE) and polytetrafluoroethylene (PTFE).

3. The laminate according to claim 1, wherein the at least one first elastomer (E1) present in the second layer ii) is at least one elastomer selected from the group consisting of ethylene-propylene polymer (EPM), ethylene-propylene-diene polymer (EPDM), ethylene-acrylate polymer (EAM), fluorocarbon polymer (FKM), acrylate polymer (ACM), ethylene-vinyl acetate polymer (EVA) and acrylonitrile-butadiene polymer (NBR).

4. The laminate according to claim 1, wherein the at least one second elastomer (E2) present in the second layer ii) is at least one elastomer selected from the group consisting of ethylene-α-C₃-C₂₀-alkene copolymer, styrene-ethylene-butylene-styrene block copolymer (SEBS), styrene-ethylene-propylene-styrene block copolymer (SEPS), styrene-ethylene-ethylene-propylene-styrene block copolymer (SEEPS) and styrene-isoprene-styrene block copolymer (SIS).

5. The laminate according to claim 1, wherein the first layer i), based on 100 parts by weight of the total amount of the at least one polyethylene polymer present in the first layer i), contains not more than 10 parts by weight of further components (K1).

6. The laminate according to claim 1, wherein the second layer ii), based on 100 parts by weight of the total amount of the elastomers (E1) and (E2) present in the second layer, contains not more than 200 parts by weight of further components (K2).

7. The laminate according to claim 1, wherein the at least one first elastomer (E1) present in the second layer ii) and/or the at least one second elastomer (E2) present in the second layer ii) are in crosslinked form.

8. The laminate according to claim 1, wherein in that the at least one first elastomer (E1) present in the second layer ii) is a non-thermoplastic elastomer.

9. A layer composite moulding comprising a laminate according to claim 1, wherein the laminate has been bonded to a fibre-reinforced plastic, wherein the first layer i) of the laminate forms an outer face of the layer composite moulding and the second layer ii) of the laminate faces the fibre-reinforced plastic.

10. The layer composite moulding according to claim 9, wherein the fibre of the fibre-reinforced plastic is at least one fibre selected from the group consisting of ultrahigh molecular weight polyethylene fibres (UHMW-PE fibres), carbon fibres and glass fibres.

11. The layer composite moulding according to claim 9, wherein the plastic of the fibre-reinforced plastic is at least one epoxy-based, polyurethane-based, poly(meth)acrylate-based, polymethyl (meth)acrylate-based or poly(meth)acrylamide-based plastic.

12. The layer composite moulding according to claim 9, wherein the laminate is bonded to the fibre-reinforced plastic by a third layer iii) comprising at least one adhesive selected from the group consisting of polyurethane adhesives, methyl (meth)acrylate adhesives and epoxy adhesives.

13. The layer composite moulding according to claim 9, wherein the layer composite moulding is a rotor blade.

14. A wind turbine comprising a layer composite moulding according to claim 9.

15. A process for producing a layer composite moulding according to claim 9, comprising:
I) producing or providing a laminate comprising at least layers i) and ii):
i) a first layer comprising at least one polyethylene polymer,
ii) a second layer comprising at least one first elastomer (E1) and at least one second elastomer (E2), where the at least one second elastomer (E2) is at least one thermoplastic elastomer selected from the group consisting of ethylene-α-olefin copolymers and styrene-alkylene block copolymers; and
II) joining the laminate produced or provided to the fibre-reinforced plastic.
